(19) United States
(12) Patent Application Publication
(10) Pub. No.: US 2010/0208571 A1
(43) Pub. Date: Aug. 19, 2010

(54) Optical Pickup Apparatus and Optical Disk Apparatus Using the Same

(75) Inventors: Hiroshi Shibata, Fukuoka (JP); Akihiro Arai, Fukuoka (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, OSAKA (JP)

(21) Appl. No.: 12/703,692

(22) Filed: Feb. 10, 2010

(30) Foreign Application Priority Data
Feb. 16, 2009 (JP) 2009-032191
Feb. 16, 2009 (JP) 2009-032192

(51) Int. Cl. G11B 7/135

(52) U.S. Cl. 369/112.24; 369/112.28; G9B/7.112

(57) ABSTRACT

An optical pickup apparatus includes a light source emitting a light, an objective lens collecting the light on an optical disk, a collimate lens that is moved in an optical axis direction along a light path of the light to change a divergent angle or a convergent angle of the light, a starting prism that expands a spot shape of an incident light in a first predetermined direction to emit the light, and a beam shaping prism that expands a spot shape of an incident light in a second predetermined direction to emit the light, and the collimate lens, the beam shaping prism, and the starting prism are disposed in order from the light source side toward the objective lens on a light path connecting the light source and the objective lens, and the first predetermined direction is perpendicular to the second predetermined direction. Thereby, it is possible to make an attempt to thin the optical pickup apparatus and an optical disk apparatus using the optical pickup apparatus.

### BACKGROUND

1. Field of the Invention

The present invention relates to an optical pickup apparatus and an optical disk apparatus using the same.

2. Description of the Related Art

A conventional optical pickup apparatus (for example, Patent Document 1 described below) is configured as follows.

That is, the conventional optical pickup apparatus is configured such that a collimate lens made freely movable in its optical axis direction and a starting prism are disposed from a light source side toward an objective lens between the light source and the objective lens.

In this conventional example, an attempt is made to thin the apparatus by disposing the starting prism below the objective lens.

Patent Document 1: JP-A-2007-213755

In the above-described conventional example, spherical aberration correction is performed by moving the collimate lens in the optical axis direction for recording and regeneration of an optical disk used for multilayer recording. The important thing here is that, in the case in which the collimate lens is made movable in the axial direction, this starting prism makes beam shaping magnification ratios of an incident light and an emitting light equal in order not to make astigmatism by the starting prism occur.

However, in the case in which beam shaping magnification ratios of an incident light and an emitting light are made equal in order to prevent an occurrence of astigmatism in this way, the light path from the light source to the starting prism must be made large in order to secure the light path to the objective lens to be large, that results in an obstacle to further thinning of the apparatus.

### SUMMARY

The present invention is to solve the above-described conventional problem, and an object of the present invention provides an optical pickup apparatus for which an attempt can be made to thin it, and an optical disk apparatus using that optical pickup apparatus.

In order to achieve the object, the present invention provides an optical pickup apparatus including a light source emitting a light, an objective lens collecting the light on an optical disk, a collimate lens that is moved in an optical axis direction along a light path of the light to change a divergent angle or a convergent angle of the light, a starting prism that expands a spot shape of an incident light in a first predetermined direction to emit it, and a beam shaping prism that expands a spot shape of an incident light in a second predetermined direction to emit it, and the collimate lens, the beam shaping prism, and the starting prism are disposed in order from the light source side toward the objective lens on a light path connecting the light source and the objective lens, and the first predetermined direction is perpendicular to the second predetermined direction, thereby achieving the desired object.

As described above, because the collimate lens that is moved in the optical axis direction on the light path, the beam shaping prism that expands a spot shape of an incident laser beam in the second predetermined direction to emit the laser beam, and the starting prism that expands a spot shape of an incident laser beam in the first predetermined direction to emit the laser beam, are disposed in order from the light source side toward the objective lens on the light path connecting the light source and the objective lens, and the first predetermined direction is made perpendicular to the second predetermined direction in the present invention, it is possible to make an attempt to thin the apparatus.

That is, in the present invention, the starting prism is configured to perform beam shaping expansion of an incident light in the first predetermined direction to emit the light. Therefore, the light path from the light source to this starting prism can be made small, thus it is possible to make an attempt to thin the apparatus.

Further, in the apparatus in which the starting prism is configured to perform beam shaping expansion of an incident light in the first predetermined direction to emit the light, the problem of astigmatism will occur. However, in the present invention, because the beam shaping prism that performs beam shaping expansion of an incident light in the second predetermined direction perpendicular to the first predetermined direction to emit the light, is disposed between the starting prism and the collimate lens, astigmatism occurring due to a divergent light or a convergent light being made incident onto the starting prism can be cancelled by astigmatism occurring by the beam shaping prism, and thus no problem with astigmatism occurs.

### BRIEF DESCRIPTION OF THE DRAWINGS

FIG. 1A is a top view in a first embodiment of the present invention.

FIG. 1B is a view showing spot shapes forming a width C and a width D.

FIG. 2A is a front view in the first embodiment of the present invention.

FIG. 2B is a view showing spot shapes forming a width A and a width B.

FIG. 3 is a top view of another embodiment of the present invention.

FIG. 4 is a front view of the embodiment.

FIG. 5 is a top view of yet another embodiment of the present invention.

FIG. 6 is a front view of the embodiment.

FIG. 7A is a top view in a second embodiment of the present invention.

FIG. 7B is a view showing spot shapes forming a width C and a width D.

FIG. 8A is a front view of a light path of a blue light in FIG. 7A.

FIG. 8B is a view showing spot shapes forming a width A and a width B.

FIG. 9A is a front view of a light path of a red light in FIG. 7A.

FIG. 9B is a view showing spot shapes forming a width A and a width B.

FIG. 10 is a top view of another embodiment of the present invention.

FIG. 11 is a front view of a light path of a blue light of the embodiment.

FIG. 12 is a front view of a light path of a red light of the embodiment.

FIG. 13 is a top view of yet another embodiment of the present invention.

FIG. 14 is a front view of a light path of a blue light of the embodiment.

FIG. 15 is a front view of a light path of a red light of the embodiment.

FIG. 16 is a top view of yet another embodiment of the present invention.

FIG. 17 is a front view of a light path of a blue light of the embodiment.

FIG. 18 is a front view of a light path of a red light of the embodiment.

### DETAILED DESCRIPTION

Hereinafter, an optical pickup apparatus that is an embodiment of the present invention, which is applied as an optical disk apparatus will be described with reference to the accompanying drawings.

### First Embodiment

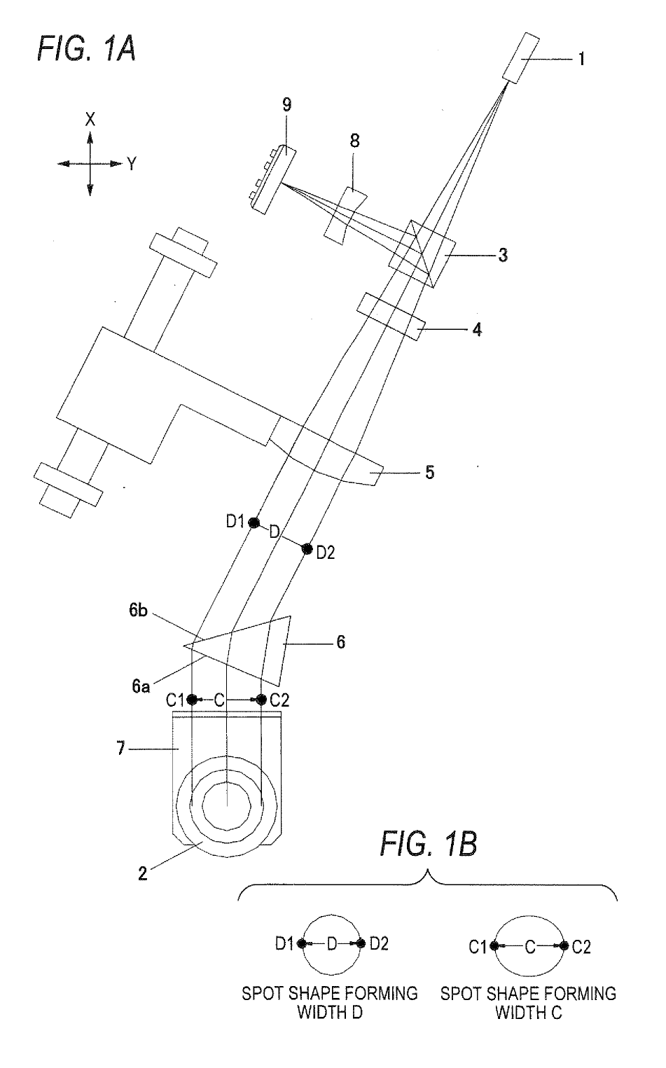

As shown in FIG. 1A, between a light source 1 emitting a blue light of 405 nm for a Blu-ray Disc (BD) and an objective lens 2, a beam splitter 3, a quarter-wavelength plate 4, a collimate lens 5, a beam shaping prism 6, and a starting prism 7 are disposed in order.

Further, as a signal detecting system, a detecting lens 8 and a light-receiving element 9 are disposed in a direction perpendicular to the light source 1 of the beam splitter 3.

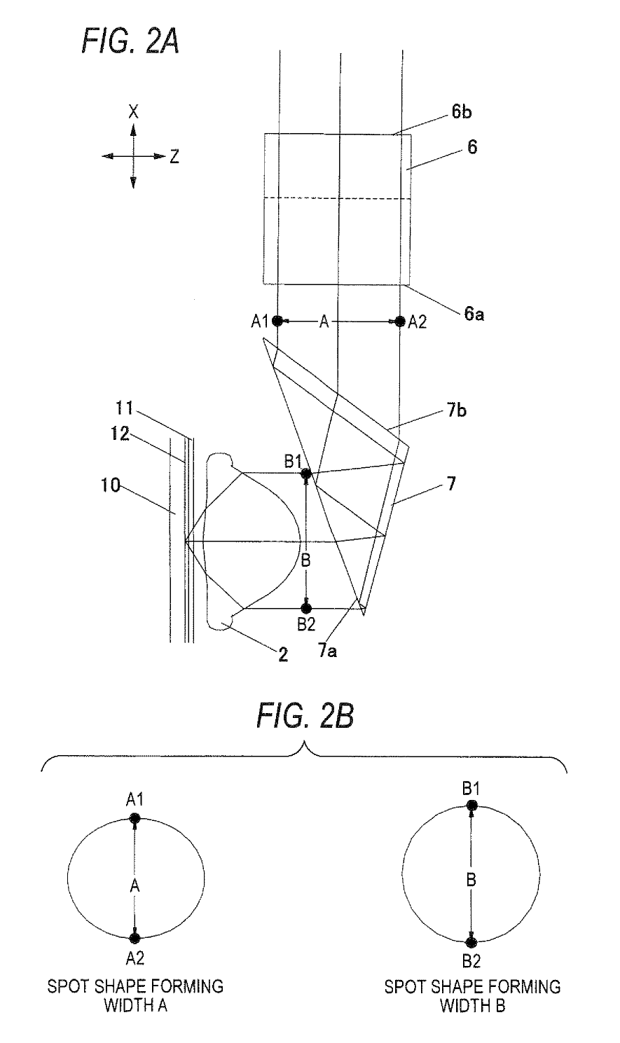

To describe its operation briefly in the above configuration, a blue light of 405 nm emitted from the light source 1 passes through the beam splitter 3, the quarter-wavelength plate 4, the collimate lens 5, the beam shaping prism 6, and the starting prism 7. Next, as shown in FIG. 2A, the blue light passes through the objective lens 2, and one of the recording layers 11 and 12 which are the upper and lower two layers of an optical disk 10 such as a BD, which is disposed thereabove, is irradiated with the blue light. Then, next, the reflected light from the recording layer 11 or 12 passes through the objective lens 2, the starting prism 7, the beam shaping prism 6, the collimate lens 5, and the quarter-wavelength plate 4. Here, the blue light emitted as a P wave from the light source 1 passes through the quarter-wavelength plate 4 twice in a reciprocating manner to be changed into an S wave. A polarization splitting film is formed on the beam splitter 3, and the reflected light from the recording layer 11 or 12 is reflected by the beam splitter 3 to reach the light-receiving element 9 via the detecting lens 8.

Hereinafter, a feature point in the present embodiment will be described.

The collimate lens 5 in the present embodiment is formed as a lens freely movable in its optical axis direction. The collimate lens 5 is moved in the optical axis direction to change a divergent angle or a convergent angle of a blue light made incident onto the objective lens 2, which makes it possible to perform correction of spherical aberration occurring in the optical disk 10 subjected to multilayer recording such as a BD. The single collimate lens 5 is made freely movable in the optical axis direction in the present invention. However, a plurality of lenses may be combined to compose the collimate lens 5, that may be configured such that only some lenses of those are made freely movable in the optical axis direction. For example, this is a configuration in which the collimate lens 5 is composed of a first lens and a second lens, and the first lens is fixed to function to make a divergent light from the light source 1 be a substantially parallel light, and the second lens is made freely movable in the optical axis direction to function to change a divergent angle or a convergent angle of the light emitted from the collimate lens 5.

In the present embodiment, the X direction of the objective lens 2 shown in FIG. 1A is set to a first predetermined direction, and a tangential direction that is a direction of the tangent of the circumference of the optical disk 10. Further, the Y direction of the objective lens 2 shown in FIG. 1A is set to a second predetermined direction, and a radial direction that is a direction of the radius of the optical disk 10. The first predetermined direction and the second predetermined direction are perpendicular to one another. Further, the Z direction shown in FIG. 2A is a thickness direction of the optical pickup apparatus. In the case of FIG. 1A, the X direction and the Y direction shown in the drawing respectively correspond to the X direction and the Y direction of the objective lens 2.

Further, with respect to a light emitted from the light source 1 to reach the objective lens 2, its tangential direction and radial direction are defined so as to correspond to a spot shape when the light reaches the objective lens 2. That is, in the case of FIG. 1A, the width C and the width D are both in the Y direction, that is defined as a radial direction. Further, in the case of FIG. 2A, the width A and the width B are both in the X direction, that is defined as a tangential direction.

As can be understood from FIG. 1A, the beam shaping prism 6 is substantially a triangle when viewed from above, and is substantially a quadrangle when viewed from the front, and one of the hypotenuses of the triangle in FIG. 1A is an emission plane 6a facing the starting prism 7 and the other side thereof is an incidence plane 6b facing the collimate lens 5. That is, the beam shaping prism 6 is configured such that the incidence plane 6b and the emission plane 6a thereof are in a nonparallel state, and performs beam shaping expansion of a light from the width D (which is numerically “9” in order to facilitate understanding) that is the radial direction of an incident light to the width C (which is numerically “10” in order to facilitate understanding) that is the radial direction of an emitting light by making an incident angle at the incidence plane 6b greater than an emitting angle at the emission plane 6a. That is, in the case in which a spot forming the width D is the spot shown on the left side in FIG. 1B, a spot forming the width C is the spot shown on the right side in FIG. 1B. Here, D1, D2, C1, and C2 shown in FIG. 1A respectively correspond to D1, D2, C1, and C2 shown in FIG. 1B.

Further, as can be understood from FIG. 2A, the starting prism 7 is configured to perform beam shaping expansion of a light from the width A (which is numerically “9” in order to facilitate understanding) that is the tangential direction of an incident light to the width B (which is numerically “10” in order to facilitate understanding) that is the tangential direction of an emitting light, to emit the light. That is, in the case in which a spot forming the width A is the spot shown on the left side in FIG. 2A, a spot forming the width B is the spot shown on the right side in FIG. 2B. Here, A1, A2, B1, and B2 shown in FIG. 2A respectively correspond to A1, A2, B1, and B2 shown in FIG. 2B. Further, in the case of the present embodiment, the emitting light from the beam shaping prism 6 and the incident light onto the starting prism 7 are the same, and therefore, the spot forming the width C in FIG. 1B and the spot forming the width A in FIG. 2B are the same.

Then, a beam shaping expansion ratio (B/A) in the tangential direction that is the first predetermined direction of the starting prism 7 and a beam shaping expansion ratio (C/D) in the radial direction that is the second predetermined direction of the beam shaping prism 6 are set to approximately the same value.

Conventionally, in order to make beam shaping expansion ratios in the tangential direction of an incident light and an emitting light be equal to one another, the width A in the tangential direction of the light path from the light source 1 to the starting prism 7 must be set to “10.” However, the starting prism 7 is capable of setting the width A in the tangential direction of the light path to “9” which is smaller in the present embodiment.

As can be understood from FIG. 1A and FIG. 2A as well, the starting prism 7 is substantially a quadrangle when viewed from above, and is substantially a triangle when viewed from the front. The objective lens 2 is made to face the lower portion of its top surface 7a and the upper portion of the top surface 7a is brought into a state of being overlapped with the objective lens 2 heightwise when viewed from the front side as shown in FIG. 2A, in which an attempt is made to thin the apparatus heightwise. Then, in that state, the starting prism 7 is in a state in which a side surface 7b faces the emission plane 6a of the beam shaping prism 6.

In the present embodiment, because the recording layers 11 and 12 are provided as the upper and lower layers to the optical disk 10 as described above, in the case in which recording or regeneration is selectively performed, the objective lens 2 facing the optical disk 10 is moved up and down and the collimate lens 5 is moved in the optical axis direction, to perform spherical aberration correction. At this time, because the collimate lens 5 differs in position in the optical axis direction in which recording or regeneration is performed with respect to the recording layer 11 and in the case in which recording or regeneration is performed with respect to the recording layer 12, a light emitted from the collimate lens 5 differs in a divergent state or a convergent state. When a divergent light or a convergent light is made incident onto the starting prism 7 for performing beam shaping expansion, astigmatism occurs, and therefore, astigmatism occurs in at least one of the case in which recording or regeneration is performed with respect to the recording layer 11 and the case in which recording or regeneration is performed with respect to the recording layer 12. In order to suppress the occurrence of astigmatism, the beam shaping prism 6 is disposed between the collimate lens 5 and the starting prism 7 in the present embodiment. That is, if the beam shaping prism 6 is disposed at this position, the beam shaping expansion ratios of a blue light in the tangential direction and the radial direction in the objective lens 2 are made approximately equal to one another, and thus the problem of astigmatism does not occur even when the collimate lens 5 is moved in the optical axis direction.

To describe this point in more detail, as described above, the starting prism 7 makes an attempt to perform beam shaping expansion in the tangential direction that is the first predetermined direction of a light passing through the objective lens 2 of FIG. 2A, and at the same time, considerable astigmatism occurs in accordance with a beam shaping expansion ratio. On the other hand, the beam shaping prism 6 makes an attempt to perform beam shaping expansion in the radial direction that is the second predetermined direction of a light passing through the objective lens 2 of FIG. 1A, and at the same time, considerable astigmatism whose polar character is different from that in the tangential direction occurs in accordance with a beam shaping expansion ratio. These beam shaping expansion ratios in the tangential direction and the radial direction of a light passing through the objective lens 2 are made the same. As a result, as described above, beam shaping expansion ratios in the tangential direction and the radial direction of a light passing through the objective lens 2 are made approximately equal to one another, and astigmatisms with different polar characters are cancelled by each other, thus no problem with astigmatism occurs.

Then, in the configuration described above, by use of the starting prism 7 for performing beam shaping expansion, a height A of the light path from the light source 1 to the starting prism 7 can be lowered even if a light path to the objective lens is secured to be large, and thus, it is possible to make an attempt to thin the optical pickup apparatus and the optical disk apparatus using the optical pickup apparatus. Additionally, in the apparatus configured in that manner, an occurrence of astigmatism according to switching of the recording layers 11 and 12 of the optical disk 10 as well is not brought about.

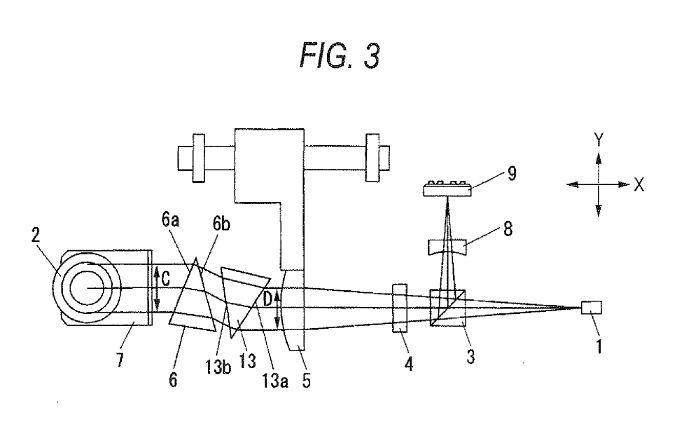

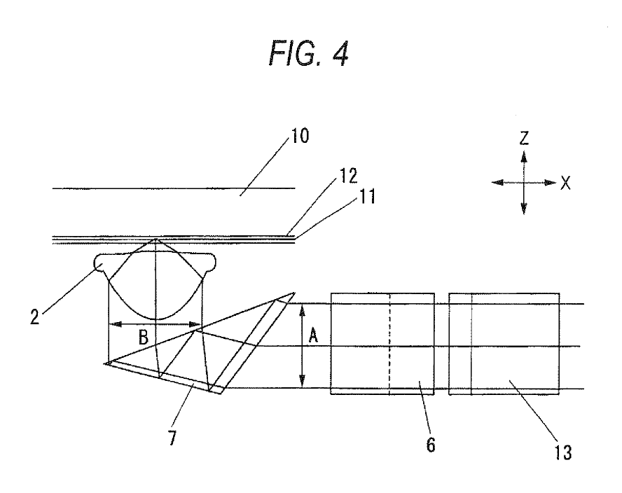

FIGS. 3 and 4 show another embodiment of the present invention, in which a light path changing prism 13 is disposed on the incidence plane 6b side of the beam shaping prism 6. That is, as is clear from FIG. 3 as well, the light path changing prism 13 is substantially a triangle when viewed from the top surface, and an incident angle at an incidence plane 13a and an emitting angle at an emission plane 13b are made the same, that is to change the light path so as to simply fold the light passing through the collimate lens 5, to supply the light to the beam shaping prism 6. Then, with such a configuration, as shown in FIG. 3, an emitting light from the light source 1 and an emitting light from the emission plane 6a of the beam shaping prism 6 to the starting prism 7 can be brought into a parallel state, and as a result, it is extremely easy to design and assemble the respective components shown in FIG. 3.

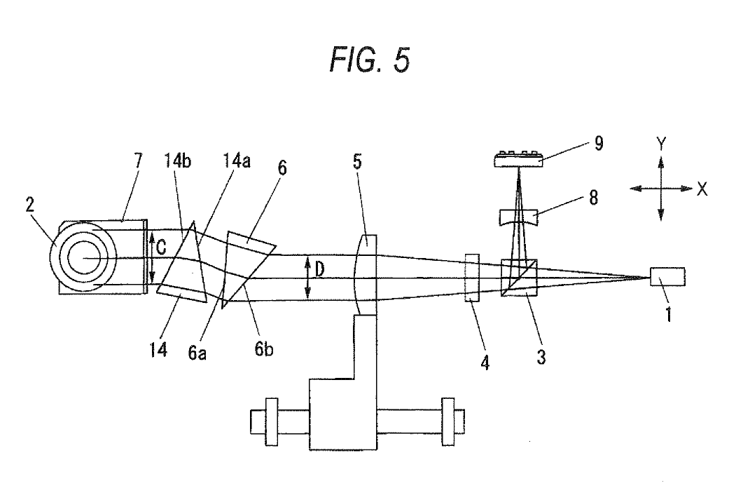

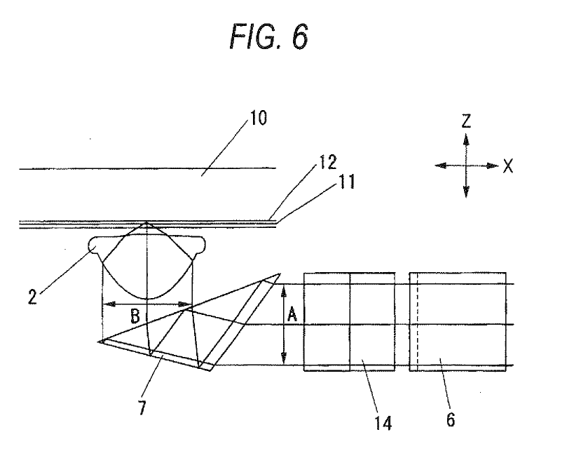

FIGS. 5 and 6 show yet another embodiment of the present invention, in which a light path changing prism 14 is disposed on the emission plane 6a side of the beam shaping prism 6. That is, the light path changing prism 14 is configured such that an incident angle at an incidence plane 14a and an emitting angle at an emission plane 14b are made the same, that is to change a light path so as to simply fold the light passing through the beam shaping prism 6, to supply the light to the starting prism 7. Then, with such a configuration, as shown in FIG. 5, an emitting light from the light source 1 and an emitting light from the emission plane 14b of the light path changing prism 14 to the starting prism 7 can be brought into a parallel state, and as a result, it is extremely easy to design and assemble the respective components shown in FIG. 5.

In addition, in the embodiments of FIGS. 3 to 6, the light path changing prisms 13 and 14 are for simply changing a light path. However, a beam shaping function may be provided to these light path changing prisms 13 and 14. Then, in this way, in the case in which a beam shaping function is provided to the light path changing prisms 13 and 14, it is important that a beam shaping expansion ratio in the second predetermined direction of a total of the beam shaping prism 6 and the light path changing prism 13 or 14 (C (which is numerically “10” in order to facilitate understanding)/D (which is numerically “9” in order to facilitate understanding)) is made to be a value approximately the same as a beam shaping expansion ratio in the first predetermined direction of the starting prism 7 (B (which is numerically “10” in order to facilitate understanding)/A (which is numerically “9” in order to facilitate understanding)).

In addition, in the present embodiment, the light source 1 is configured to emit a blue light of 405 nm for a BD. However, the light source 1 may be configured to emit a red light of 650 nm for a DVD. That is, the light source 1 is used for recording and regeneration in multilayer recording, and its wavelength is not a problem.

### Second Embodiment

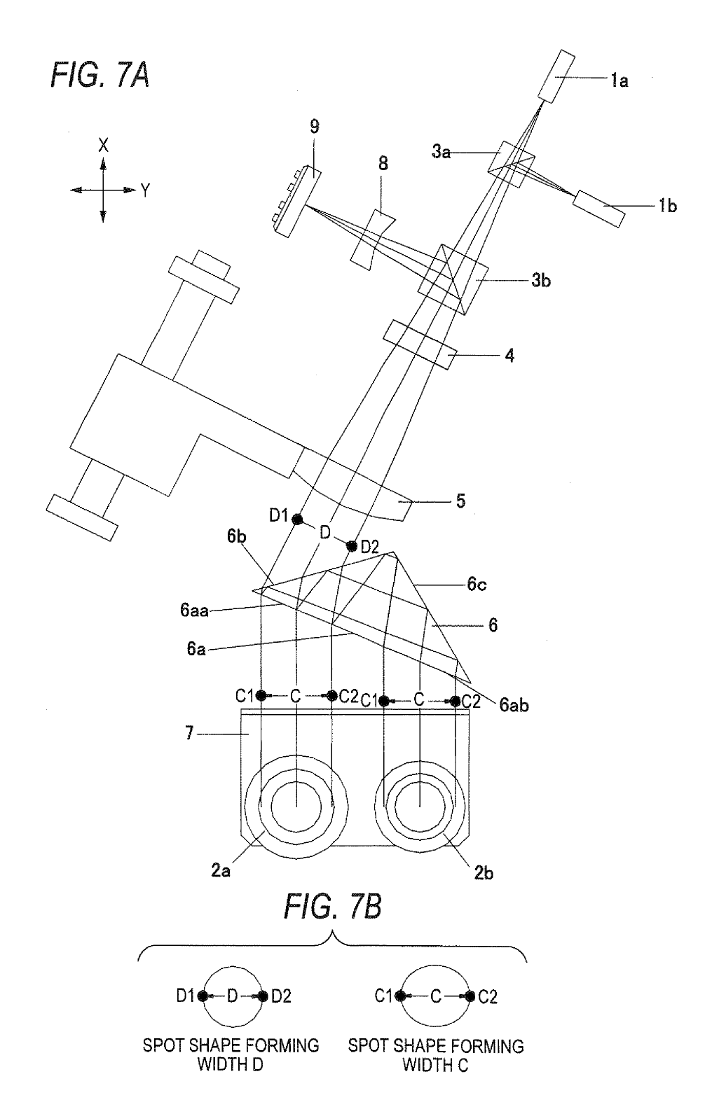

As shown in FIG. 7A, between a light source la emitting a blue light of 405 nm for a Blu-ray Disc (BD) and a light source 1b emitting a red light of 650 nm for a DVD, and an objective lens 2a for a BD and an objective lens 2b for a DVD, an optical coupler 3a, a beam splitter 3b, the quarter-wavelength plate 4, the collimate lens 5, the beam shaping prism 6, and the starting prism 7 are disposed in order from the light sources 1a and 1b toward the objective lenses 2a and 2b. The objective lens 2a for a BD is made to face a part of the starting prism 7, and the objective lens 2b for a DVD is made to face another part of the starting prism 7.

Further, as a signal detecting system, the detecting lens 8 and the light-receiving element 9 are disposed in a direction perpendicular to the light sources 1a and 1b of the beam splitter 3b.

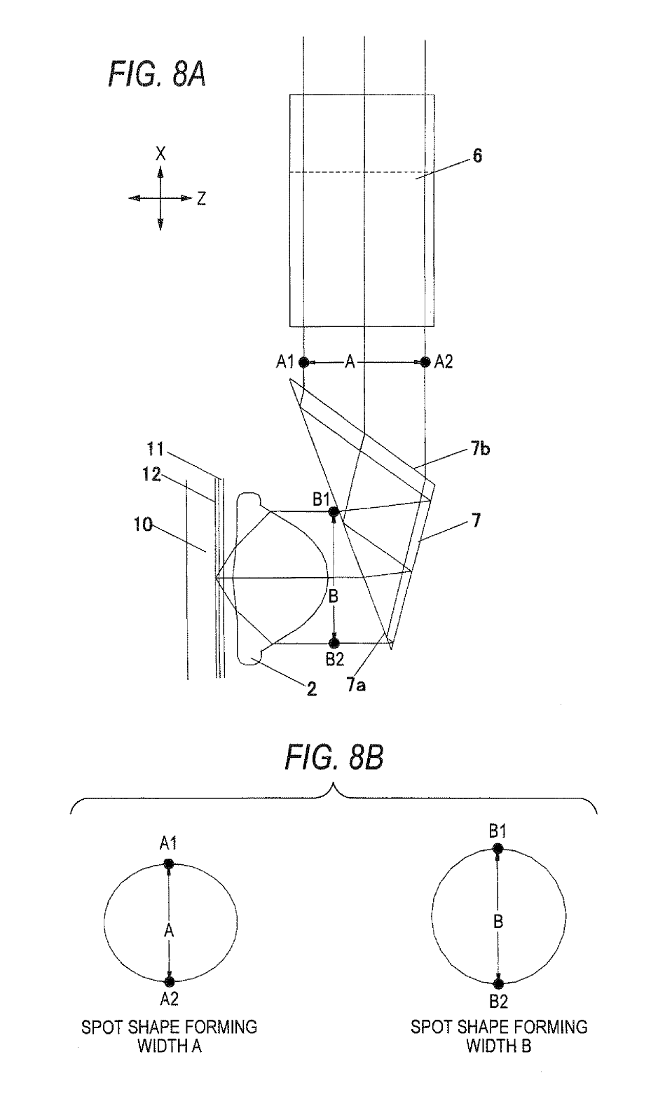

To describe its operation briefly in the above configuration, first, a blue light of 405 nm emitted from light source 1a for a BD passes through the optical coupler 3a, the beam splitter 3b, the quarter-wavelength plate 4, the collimate lens 5, the beam shaping prism 6, and the starting prism 7, Next, as shown in FIG. 8A, the blue light passes through the objective lens 2a, and one of the recording layers 11a and 12a which are the upper and lower two layers of an optical disk (BD) 10a, which is disposed thereabove, is irradiated with the blue light. Then, next, the reflected light from the recording layer 11a or 12a passes through the objective lens 2a, the starting prism 7, the beam shaping prism 6, the collimate lens 5, and the quarter-wavelength plate 4. Here, the blue light emitted as a P wave from the light source 1 passes through the quarter-wavelength plate 4 twice in a reciprocating manner to be changed into an S wave. A polarization splitting film is formed on the beam splitter 3b, and the reflected light from the recording layer 11a or 12a is reflected by the beam splitter 3b, to reach the light-receiving element 9 via the detecting lens 8.

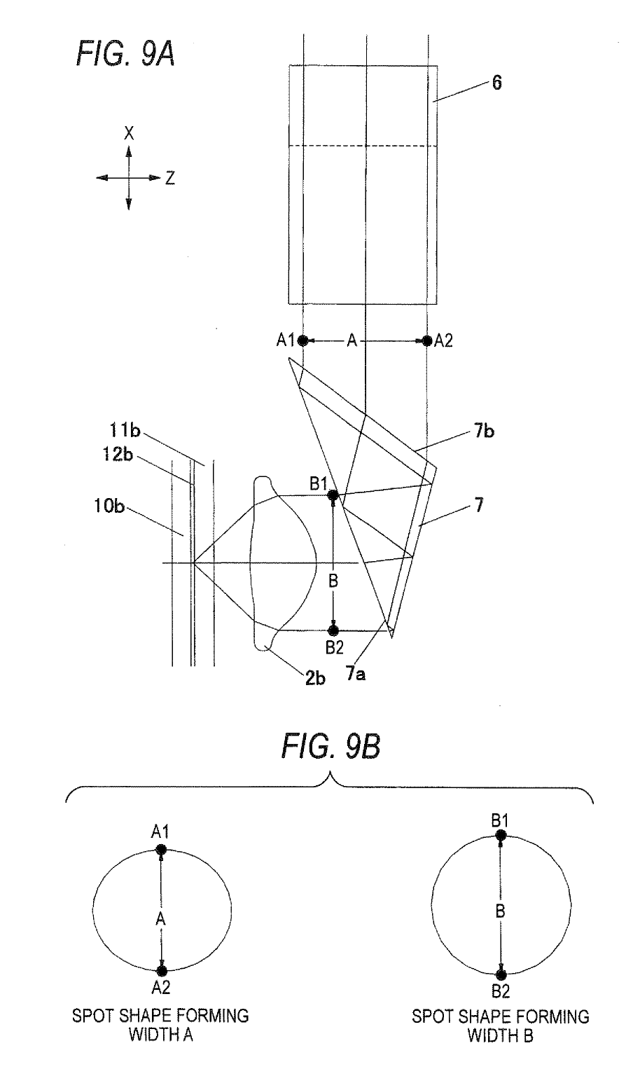

Next, a red light of 650 nm emitted from light source 1b for a DVD passes through the optical coupler 3a, the beam splitter 3b, the quarter-wavelength plate 4, the collimate lens 5, the beam shaping prism 6, and the starting prism 7. Next, as shown in FIG. 9A, the red light passes through the objective lens 2b, and one of the recording layers 11b and 12b which are the upper and lower two layers of an optical disk (DVD) 10b, which is disposed thereabove, is irradiated with the red light. Then, next, the reflected light from the recording layer 11b or 12b passes through the objective lens 2b, the starting prism 7, the beam shaping prism 6, the collimate lens 5, and the quarter-wavelength plate 4. Here, the red light emitted as a P wave from the light source 1b passes through the quarter-wavelength plate 4 twice in a reciprocating manner to be changed into an S wave. A polarization splitting film is formed on the beam splitter 3b, and the reflected light from the recording layer 11b or 12b is reflected by the beam splitter 3b, to reach the light-receiving element 9 via the detecting lens 8.

Hereinafter, a feature point in the present embodiment will be described.

The collimate lens 5 in the present embodiment is formed as a lens freely movable in its optical axis direction. The collimate lens 5 is moved in the optical axis direction to change a divergent angle or a convergent angle of a blue light made incident onto the objective lens 2a, or a divergent angle or a convergent angle of a red light made incident onto the objective lens 2b, which makes it possible to perform correction of spherical aberration occurring in the optical disk 10 subjected to multilayer recording such as a BD or a DVD. The single collimate lens 5 is made freely movable in the optical axis direction in the present invention. However, a plurality of lenses may be combined to compose the collimate lens 5, that may be configured such that only some lenses of those are made freely movable in the optical axis direction. For example, that is a configuration in which the collimate lens 5 is composed of a first lens and a second lens, and the first lens is fixed to function to make a divergent light from the light source 1 be a substantially parallel light, and the second lens is made freely movable in the optical axis direction to function to change a divergent angle or a convergent angle of the light emitted from the collimate lens 5.

In the present embodiment, the X direction of the objective lens 2 shown in FIG. 7A is set to a first predetermined direction, and a tangential direction that is a direction of the tangent of the circumference of the optical disk 10. Further, the Y direction of the objective lens 2 shown in FIG. 7A is set to a second predetermined direction, and a radial direction that is a direction of the radius of the optical disk 10. The first predetermined direction and the second predetermined direction are perpendicular to one another. Further, the Z direction shown in FIG. 8A is a thickness direction of the optical pickup apparatus. In the case of FIG. 7A, the X direction and the Y direction shown in the drawing respectively correspond to the X direction and the Y direction of the objective lens 2.

Further, with respect to a light emitted from the light source 1 to reach the objective lens 2, its tangential direction and radial direction are defined so as to correspond to a spot shape when the light reaches the objective lens 2. That is, in the case of FIG. 7A, the width C and the width D are both in the Y direction, that is defined as a radial direction. Further, in the case of FIG. 8A, the width A and the width B are both in the X direction, that is defined as a tangential direction.

As can be understood from FIG. 7A, the beam shaping prism 6 is substantially a triangle when viewed from above, and is substantially a quadrangle when viewed from the front, and the base of the triangle is an emission plane 6a facing the starting prism 7, and one of the hypotenuses in FIG. 7A is an incidence plane 6b facing the collimate lens 5. Further, the other side of the two hypotenuses is, as will be described later, a reflection plane 6c reflecting a red light for a DVD.

A blue light for a BD is made incident from the incidence plane 6b of the beam shaping prism 6, and is transmitted to be directly emitted from a part 6aa of the emission plane 6a. On the other hand, a red light for a DVD is made incident from the incidence plane 6b of the beam shaping prism 6, to be reflected by the part baa of the emission plane 6a, and is again made incident onto the incidence plane 6b. The red light is reflected by the incidence plane 6b, and is further reflected by the reflection plane 6c, and is transmitted to be emitted from another part 6ab of the emission plane 6a. At this time, the apparatus is designed such that the blue light and the red light emitted from the emission plane 6a are made parallel to each other. In this way, the beam shaping prism 6 functions as a beam splitter as well, emitting a blue light and a red light traveling along substantially the same light path in parallel from different positions.

Here, the beam shaping prism 6 is configured such that the incidence plane 6b and the emission plane 6a thereof are in a nonparallel state, and performs beam shaping expansion of a light from the width D (which is numerically “9” in order to facilitate understanding) that is the radial direction of an incident light to the width D (which is numerically “10” in order to facilitate understanding) that is the radial direction of an emitting light by making an incident angle at the incidence plane 6b greater than an emitting angle at the emission plane 6a. That is, in the case in which a spot forming the width D is the spot shown on the left side in FIG. 7B, a spot forming the width C is the spot shown on the right side in FIG. 7B. Here, D1, D2, C1, and C2 shown in FIG. 7A respectively correspond to D1, D2, C1, and C2 shown in FIG. 7B.

Further, as can be understood from FIGS. 8A and 9B, the starting prism 7 is configured to perform beam shaping expansion of a light from the width A (which is numerically “9” in order to facilitate understanding) that is the tangential direction of an incident light to the width B (which is numerically “10” in order to facilitate understanding) that is the tangential direction of an emitting light to emit the light. That is, in the case in which a spot forming the width A is the spot shown on the left side in FIG. 8B, a spot forming the width B is the spot shown on the right side in FIG. 8B. Further, in the case in which a spot forming the width A is the spot shown on the left side in FIG. 9B, a spot forming the width B is the spot shown on the right side in FIG. 9B. Here, A1, A2, B1, and B2 shown in FIG. 8A respectively correspond to A1, A2, B1, and B2 shown in FIG. 8B. Further, in the case of the present embodiment, the emitting light from the beam shaping prism 6 and the incident light onto the starting prism 7 are the same, and therefore, the spot forming the width C in FIG. 7B and the spot forming the width A in FIG. 8B are the same. Then, a beam shaping expansion ratio (B/A) in the tangential direction that is the first predetermined direction of the starting prism 7 and a beam shaping expansion ratio (C/D) in the radial direction that is the second predetermined direction of the beam shaping prism 6 are set to approximately the same value.

As can be understood from FIGS. 7A, 8B, and 9C as well, the starting prism 7 is substantially a quadrangle when viewed from above, and is substantially a triangle when viewed from the front. As shown in FIG. 7A, the objective lens 2a is made to face one side of the lower portion of the top surface 7a and the objective lens 2b is made to face the other side thereof. Further, the upper portion of the top surface 7a is brought into a state of being overlapped with the objective lenses 2a and 2b heightwise when viewed from the front side as shown in FIGS. 8A and 9A, in which an attempt is made to thin the apparatus heightwise. Then, in that state, the starting prism 7 is in a state in which the side surface 7b faces the emission plane 6a of the beam shaping prism 6. In the present embodiment, the single starting prism 7 functions as prisms for a BD and for a DVD. However, the starting prisms 7 may be separately provided. Provided that the starting prism 7 is used as both prisms for a BD and a DVD, it is possible to manufacture the apparatus inexpensively, and in contrast thereto, provided that the starting prisms 7 are separately provided, it is possible to further improve the respective characteristics.

In the present embodiment, because the recording layers 11a and 12a are provided as the upper and lower layers to the optical disk 10a as described above, in the case in which recording or regeneration is selectively performed, the objective lens 2a facing the optical disk 10a is moved up and down and the collimate lens 5 is moved in the optical axis direction, to perform spherical aberration correction. At this time, because the collimate lens 5 differs in position in the optical axis direction in the case in which recording or regeneration is performed with respect to the recording layer 11a and in the case in which recording or regeneration is performed with respect to the recording layer 12a, a blue light emitted from the collimate lens 5 differs in a divergent state or a convergent state. When a divergent light or a convergent light is made incident onto the starting prism 7 for performing beam shaping expansion, astigmatism occurs, and therefore, astigmatism occurs in at least one of the case in which recording or regeneration is performed with respect to the recording layer 11a and the case in which recording or regeneration is performed with respect to the recording layer 12a. In order to suppress the occurrence of astigmatism, the beam shaping prism 6 is disposed between the collimate lens 5 and the starting prism 7 in the present embodiment. That is, if the beam shaping prism 6 is disposed at this position, the beam shaping expansion ratios of the blue light in the tangential direction and the radial direction in the objective lens 2a are made approximately equal to one another, and thus the problem of astigmatism does not occur even when the collimate lens 5 is moved in the optical axis direction.

In the same way, because the recording layers 11b and 12b are provided as the upper and lower layers to the optical disk 10b, in the case in which recording or regeneration is selectively performed, the objective lens 2b facing the optical disk 10b is moved up and down and the collimate lens 5 is moved in the optical axis direction, to perform spherical aberration correction. At this time, because the collimate lens 5 differs in position in the optical axis direction in the case in which recording or regeneration is performed with respect to the recording layer 11b and in the case in which recording or regeneration is performed with respect to the recording layer 12b, a red light emitted from the collimate lens 5 differs in a divergent state or a convergent state. When a divergent light or a convergent light is made incident onto the starting prism 7 for performing beam shaping expansion, astigmatism occurs, and therefore, astigmatism occurs in at least one of the case in which recording or regeneration is performed with respect to the recording layer 11b and the case in which recording or regeneration is performed with respect to the recording layer 12b. In order to suppress the occurrence of astigmatism, the beam shaping prism 6 is disposed between the collimate lens 5 and the starting prism 7 in the present embodiment. That is, if the beam shaping prism 6 is disposed at this position, the beam shaping expansion ratios of the red light in the tangential direction and the radial direction in the objective lens 2b are made approximately equal to one another, and thus no problem with astigmatism occurs even when the collimate lens 5 is moved in the optical axis direction.

To describe this point in more detail, as described above, the starting prism 7 makes an attempt to perform beam shaping expansion in the tangential direction that is the first predetermined direction of a blue light passing through the objective lens 2a of FIG. 8A and a red light passing through the objective lens 2b of FIG. 9A, and at the same time, considerable astigmatism occurs in accordance with a beam shaping expansion ratio. On the other hand, the beam shaping prism 6 makes an attempt to perform beam shaping expansion in the radial direction that is the second predetermined direction of the lights passing through the objective lenses 2a and 2b of FIG. 7, and at the same time, considerable astigmatism occurs in a direction perpendicular to the tangential direction in accordance with a beam shaping expansion ratio. These beam shaping expansion ratios in the tangential direction and the radial direction of the lights passing through the objective lenses 2a and 2b are made the same. As a result, as described above, beam shaping expansion ratios in the tangential direction and the radial direction of a blue light passing through the objective lens 2a and a red light passing through the objective lens 2b are made approximately equal to one another, and astigmatisms in directions perpendicular to one another are cancelled by each other, thus no problem with astigmatism occurs.

As described above, in accordance with the configuration of the present invention, a height of the light path from the light sources 1a and 1b to the starting prism 7 can be lowered. Thereby, it is possible to make an attempt to thin the optical pickup apparatus and the optical disk apparatus using the optical pickup apparatus. Additionally, an occurrence of astigmatism according to switching of the recording layers 11a and 12a of the optical disk 10a and switching of the recording layers 11b and 12b of the optical disk 10b as well is not brought about.

The beam shaping prism 6 having the above-described property will be described in more detail.

In order to split a blue light and a red light, a wavelength selective film is formed on the part 6aa of the emission plane 6a. This wavelength selective film is a film having a property of transmitting a blue light of 405 nm for a BD and reflecting a red light for a DVD. By forming the wavelength selective film, a blue light is transmitted to be emitted and a red light is reflected by the part 6aa of the emission plane 6a, which makes it possible to split the blue light and the red light. Further, the wavelength selective film is not formed on the other part 6ab of the emission plane 6a, and an antireflective film is formed or a film itself is not provided thereon. In this way, the other part 6ab of the emission plane 6a is capable of transmitting a red light to emit the red light.

Further, an antireflective film may be formed on the surface of the incidence plane 6b. Further, a reflective film is formed on the surface of the reflection plane 6c. By forming a reflective film thereon, it is possible to reflect a red light made incident onto the reflection plane 6c. Or, if a reflective film is not formed thereon, an incident angle of a red light made incident onto the reflection plane 6c may be set to a critical angle or more. By setting an incident angle to a critical angle or more, a red light is reflected by the reflection plane 6c.

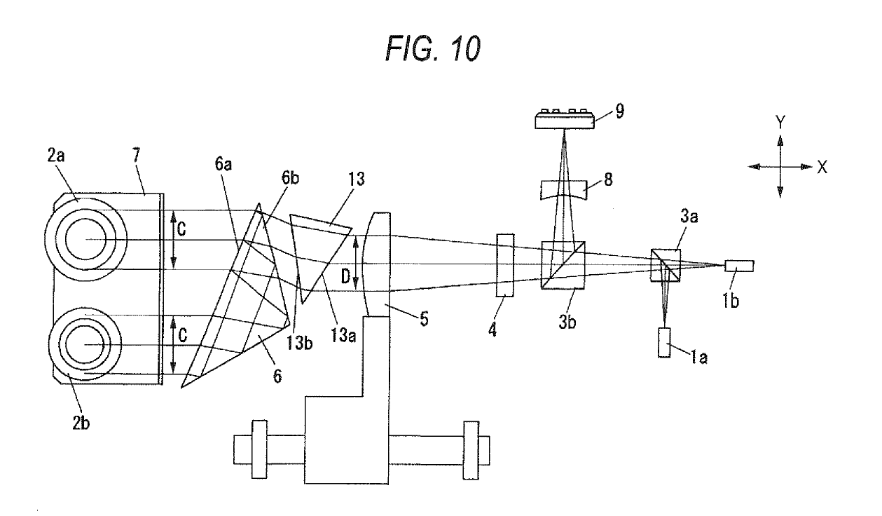

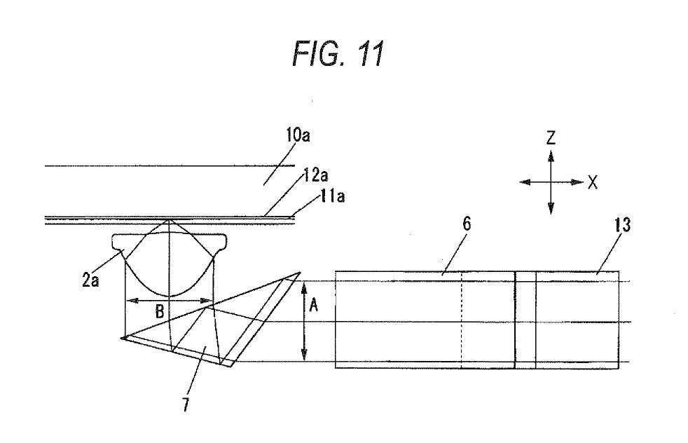

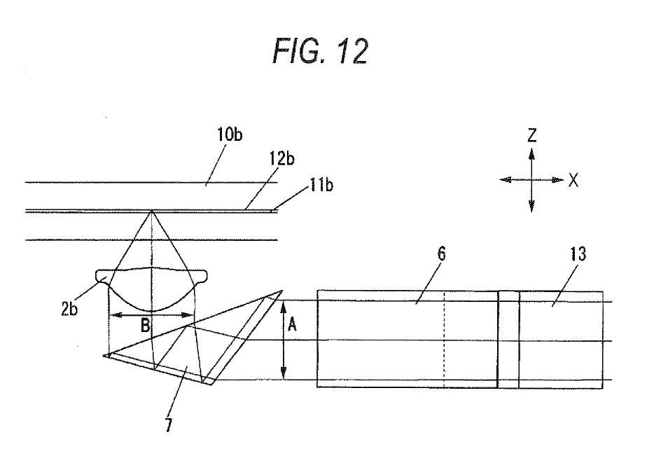

FIGS. 10, 11, and 12 show another embodiment of the present invention, in which the light path changing prism 13 is disposed on the incidence plane 6b side of the beam shaping prism 6. That is, as is clear from FIG. 10 as well, the light path changing prism 13 is substantially a triangle when viewed from the top surface, and an incident angle at the incidence plane 13a and an emitting angle at the emission plane 13b are made the same, that is to change the light path so as to simply fold the light passing through the collimate lens 5, to supply the light to the beam shaping prism 6. With such a configuration, as shown in FIG. 10, an emitting light from the light sources 1a and 1b and an emitting light from the emission plane 6a of the beam shaping prism 6 to the starting prism 7 can be brought into a parallel state, and as a result, it is extremely easy to design and assemble the respective components shown in FIG. 10.

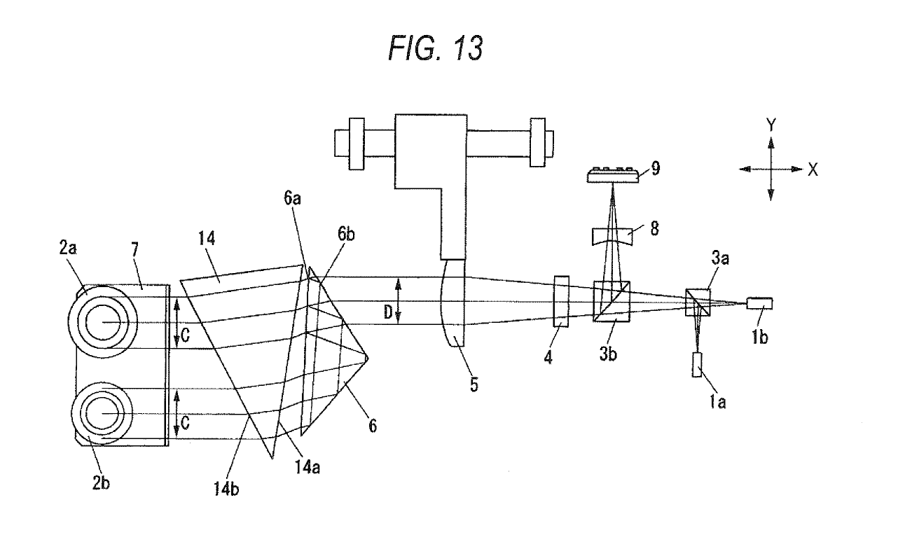

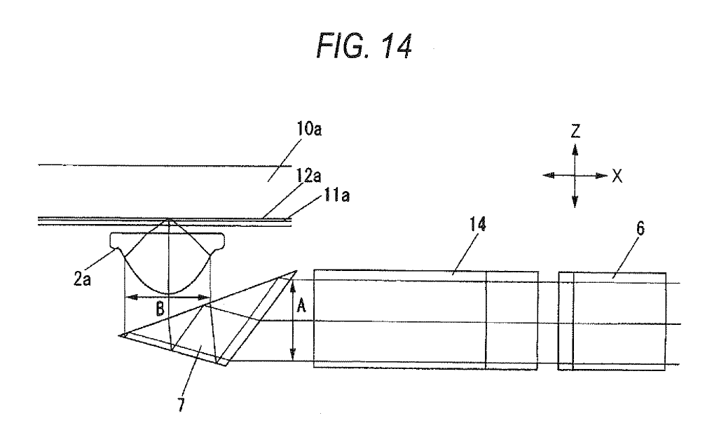

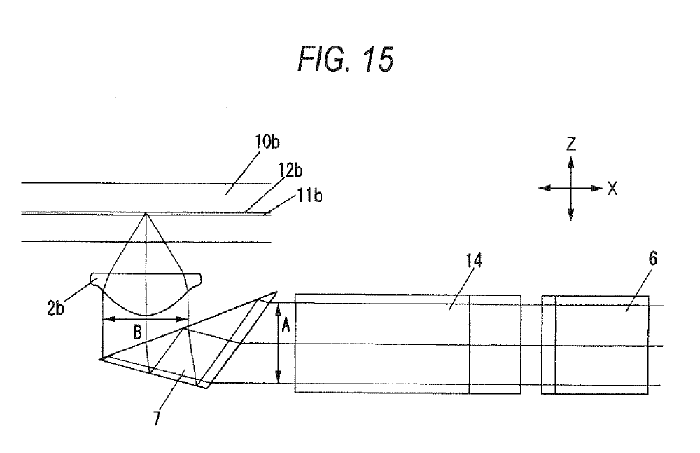

FIGS. 13, 14, and 15 show yet another embodiment of the present invention, in which the light path changing prism 14 is disposed on the incidence plane 6b side of the beam shaping prism 6. That is, the light path changing prism 14 is configured such that an incident angle at an incidence plane 14a and an emitting angle at an emission plane 14b are made the same, that is to change a light path so as to simply fold the light passing through the beam shaping prism 6, to supply the light to the starting prism 7. With such a configuration, as shown in FIG. 13, an emitting light from the light sources 1a and 1b and an emitting light from the emission plane 14b of the light path changing prism 14 to the starting prism 7 can be brought into a parallel state, and as a result, it is extremely easy to design and assemble the respective components shown in FIG. 13.

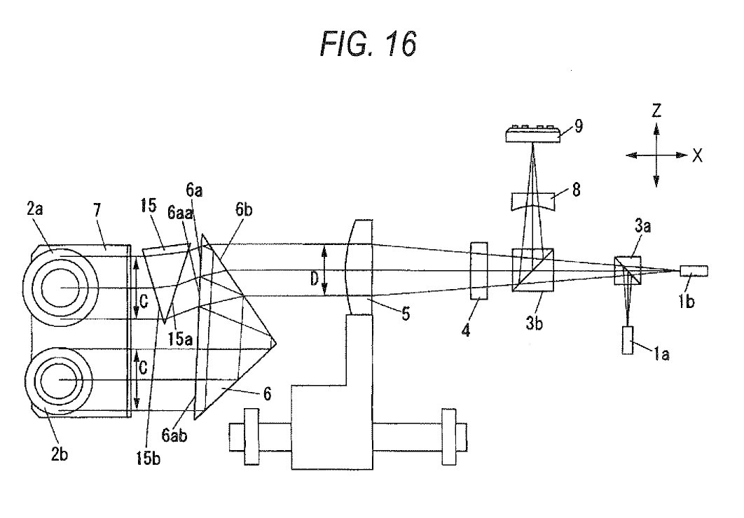

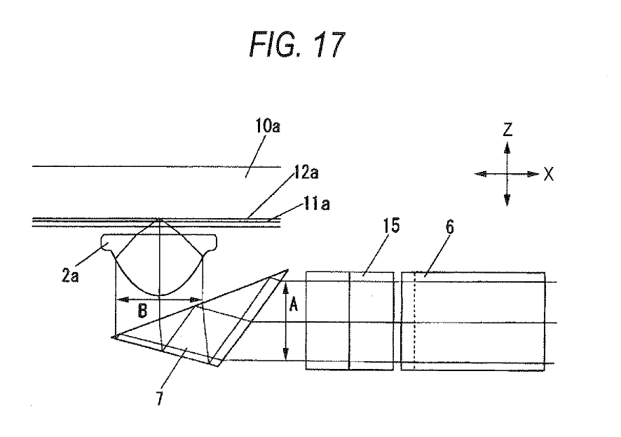

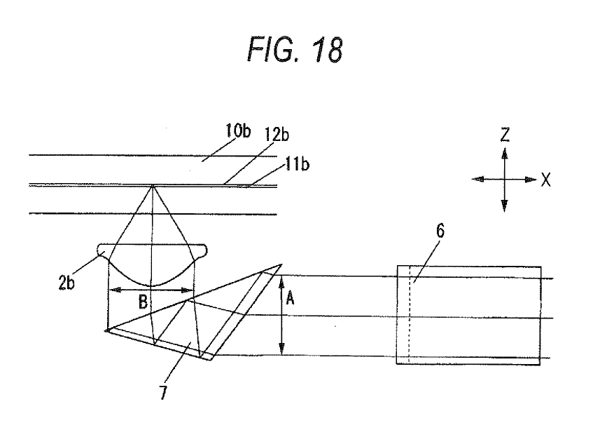

FIGS. 16, 17, and 18 show yet another embodiment of the present invention, in which a light path changing prism 15 is disposed on a light path of a blue light emitted from the part 6aa on the emission plane 6a side of the beam shaping prism 6 to head toward the objective lens 2a, but is not disposed on a light path of a red light emitted from the other part 6ab to head toward the objective lens 2b. That is, the light path changing prism 15 is configured such that an incident angle at an incidence plane 15a and an emitting angle at an emission plane 15b are made the same, that is to change a light path so as to simply fold only a blue light of the light passing through the beam shaping prism 6, to supply the blue light to the starting prism 7. With such a configuration, as shown in FIG. 16, an emitting light from the light source 1a that is a blue light and an emitting light from the emission plane 15b of the light path changing prism 15 to the starting prism 7 can be brought into a parallel state. Further, with respect to a red light, the apparatus is designed such that an emitting light from the light source 1b that is a red light and an emitting light from the other part 6ab of the emission plane 6a of the beam shaping prism 6 to the starting prism 7 are brought into a parallel state in a state without the light path changing prism 15. As a result, it is extremely easy to design and assemble the respective components shown in FIG. 16. As can be understood from FIGS. 13 and 16, the light path changing prism 15 is smaller than the light path changing prism 14, thus the entire optical system can be made smaller.

In addition, in the present embodiment, the light path changing prism 15 is disposed on only the light path of a blue light emitted from the part 6aa on the emission plane 6a side of the beam shaping prism 6 to head toward the objective lens 2a. However, the light path changing prism 15 may be disposed on the light path of a red light emitted from the other part 6ab on the emission plane 6a side of the beam shaping prism 6 to head toward the objective lens 2b.

As can be understood from FIG. 16 as well, in the case of using the light path changing prism 15, an incident angle of a red light made incident onto the emission plane 6a of the beam shaping prism 6 differs in the case in which the red light is made incident onto the part 6aa of the emission plane 6a from the incidence plane 6b and in the case in which the red light is made incident onto the other part 6ab of the emission plane 6a from the reflective plane 6c after repetitive reflection. Then, a wavelength selective incident angle splitting film may be formed on the entire surface of the emission plane 6a. Here, the wavelength selective incident angle splitting film is a film that differs in reflectance/transmittance according to a wavelength and an incident angle of an incident light, and a film for reflecting or transmitting the light according to a wavelength and an incident angle of an incident light, to split the light. In detail, the wavelength selective incident angle splitting film transmits a blue light of 405 nm and reflects a red light of 650 nm at an incident angle of a light made incident onto the part 6aa of the emission plane 6a from the incidence plane 6b, and transmits the same red light of 650 nm at an incident angle of a light made incident onto the other part 6ab of the emission plane 6a from the reflection plane 6c. By use of such a wavelength selective incident angle splitting film, only a blue light is emitted from the part 6aa of the emission plane 6a, and only a red light is emitted from the other part 6ab of the emission plane 6a, which makes it possible to split the blue light and the red light to emit those from different positions. The aforementioned wavelength selective film may be formed on only the part 6aa of the emission plane 6a. However, provided that a wavelength selective incident angle splitting film is formed on the entire surface, it is possible to more easily manufacture the apparatus.

In addition, in the embodiments of FIGS. 10 to 18, the light path changing prisms 13, 14, and 15 are for simply changing a light path. However, a beam shaping function may be provided to these light path changing prisms 13, 14, and 15. In this way, in the case in which a beam shaping function is provided to these light path changing prisms 13, 14, and 15, it is important that a beam shaping expansion ratio in the second predetermined direction of a total of the beam shaping prism 6 and the light path changing prism 13, 14, or 15 (C (which is numerically “10” in order to facilitate understanding)/D (which is numerically “9” in order to facilitate understanding)) is made to be a value approximately the same as a beam shaping expansion ratio in the first predetermined direction of the starting prism 7 (B (which is numerically “10” in order to facilitate understanding)/A (which is numerically “9” in order to facilitate understanding)).

In addition, in the present embodiment, the light source 1a is configured to emit a blue light of 405 nm for a BD, and the light source 1b is configured to emit a red light of 650 nm for a DVD. However, those are not limited thereto. That is, the light sources 1a and 1b are used for recording and regeneration in multilayer recording, and its wavelength is not a problem. Further, the light source 1b may be configured to emit an infrared light of 780 nm for CD as well. At that time, provided that the characteristics of the respective optical components are designed such that the infrared light has the same light path as a red light, there is no need to separately provide optical components for infrared light, which makes it possible to simplify its configuration.

This application claims the benefit of Japanese Patent application No. 2009-32191 filed on Feb. 16, 2009, and Japanese Patent application No. 2009-32192 filed on Feb. 16, 2009, the entire contents of which are incorporated herein by reference.

What is claimed is:

1. An optical pickup apparatus, comprising:
a light source emitting a light;
an objective lens collecting the light on an optical disk;
a collimate lens moved in an optical axis direction along a light path of the light to change a divergent angle or a convergent angle of the light;
a starting prism expanding a spot shape of an incident light in a first predetermined direction so as to emit the light; and
a beam shaping prism expanding a spot shape of an incident light in a second predetermined direction so as to emit the light, wherein
the collimate lens, the beam shaping prism, and the starting prism are disposed in order from the light source side toward the objective lens on a light path connecting the light source and the objective lens, and the first predetermined direction is perpendicular to the second predetermined direction.

2. The apparatus according to claim 1, wherein the beam shaping prism is configured such that its incidence plane and emission plane are nonparallel to each other.

3. The apparatus according to claim 1, wherein the beam shaping prism makes an incident angle at the incidence plane greater than an emitting angle at the emission plane.

4. The apparatus according to claim 1, wherein an expansion ratio in the first predetermined direction by the starting prism and an expansion ratio in the second predetermined direction by the beam shaping prism are set to approximately the same value.

5. The apparatus according to claim 1, further comprising
a light path changing prism, changing the light path of the light, wherein the light path changing prism is disposed at a position facing the incidence plane or the emission plane of the beam shaping prism.

6. The apparatus according to claim 5, wherein the light path changing prism has a function of expanding a spot shape of an incident light in the second predetermined direction to emit the light.

7. The apparatus according to claim 6, wherein an expansion ratio in the second predetermined direction by the beam shaping prism and the light path changing prism and an expansion ratio in the first predetermined direction by the starting prism are set to approximately the same value.

8. The apparatus according to claim 1, wherein
as the light source, there are at least two of a first light source emitting a light with a first wavelength and a second light source emitting a light with a second wavelength different from the first wavelength, and
the objective lens is composed of at least two of a first objective lens corresponding to the first wavelength and a second objective lens corresponding to the second wavelength.

9. The apparatus according to claim 8, wherein
a part of the emission plane of the beam shaping prism is served as an emission plane to the first objective lens, and another part thereof is served as an emission plane to the second objective lens.

10. The apparatus according to claim 9, wherein the beam shaping prism is formed into a triangle, and one hypotenuse thereof is served as an incidence plane, and a base thereof is served as an emission plane.

11. The apparatus according to claim 10, wherein the light with the first wavelength is made incident from the incidence plane of the beam shaping prism, to be directly emitted from the part of the emission plane, and the light with the second wavelength is made incident from the incidence plane of the beam shaping prism to be reflected by the emission plane, to be reflected by the incidence plane, and is further reflected by a reflection plane that is the other hypotenuse of the triangle to be emitted from the other part of the emission plane.

12. The apparatus according to claim 7, wherein a wavelength selective film for transmitting the light with the first wavelength and reflecting the light with the second wavelength is provided on at least a part of the emission plane.

13. The apparatus according to claim 11, wherein an incident angle of a light reflected from the emission plane onto the incidence plane of the beam shaping prism, toward the emission plane of the incidence plane is set to a critical angle or more.

14. The apparatus according to claim 13, wherein a light path changing prism that changes the light path of the light is disposed at a position corresponding to a light path of the first objective lens on the emission plane side of the beam shaping prism.

15. The apparatus according to claim 14, wherein a wavelength selective incident angle splitting film that differs in reflectance or transmittance according to a wavelength and an incident angle of an incident light, is formed on the entire surface of the emission plane of the beam shaping prism.

16. The apparatus according to claim 8, wherein the first objective lens is made to face a part of the starting prism, and the second objective lens is made to face another part of the starting prism.

17. The apparatus according to claim 8, wherein the second light source emits a light with a third wavelength different from the light with the first wavelength and the light with the second wavelength.

18. An optical disk apparatus comprising the optical pickup apparatus according to claim 1.

19. An optical disk apparatus comprising the optical pickup apparatus according to claim 8.
